(19) United States
(12) Patent Application Publication
(10) Pub. No.: US 2023/0323504 A1
(43) Pub. Date: Oct. 12, 2023

(54) SYSTEM FOR OXYGEN DIFFUSION IN TANKS FOR LEACHING AND DESTRUCTION OF CYANIDE CRYOMINING

(71) Applicant: CRYOINFRA S.A. DE C.V., Estado de México (MX)

(72) Inventors: María de los Ángeles CASALES HERNANDEZ, Ciudad de México (MX); Daniel ZÚÑIGA FRANCO, Estado de México (MX); José Arturo QUINTERO MORALES, Ciudad de México (MX)

(21) Appl. No.: 18/042,410

(22) PCT Filed: Aug. 18, 2021
(86) PCT No.: PCT/IB2021/057587

§ 371 Date: Feb. 21, 2023

(30) Foreign Application Priority Data
Aug. 20, 2020 (MX) MX/A/2020/008753

(51) Int. Cl. C22B 3/02; C22B 3/06; C22B 11/08

(52) U.S. Cl. CPC C22B 3/02; C22B 3/06; C22B 11/08

(57) ABSTRACT

The present invention refers to the recovery of high-value metals such as gold and silver from ores containing them by the leaching process that is carried out in tanks or reactors, and to the destruction of cyanide, which is carried out in cyanide destruction (detox) tanks at the end of the leaching process, to avoid damage to the environment. An oxygen diffuser with a specific design is provided which is used in pulp leaching tanks and in cyanide destruction (detox) tanks containing residual pulp, with the application of oxygen, whereby better results are obtained in the recovery of metals, in the application of oxygen and in retention time, among others.

### FIELD OF THE INVENTION

The present invention belongs to the field of Mineral Beneficiation, and specifically to oxygen diffusion in leaching tanks or reactors for gold and silver beneficiation and cyanide destruction (detox process).

### BACKGROUND OF THE INVENTION

There are various documents in the art of aforementioned field of invention; below, we will refer to those that are known to the applicant.

U.S. Pat. No. 4,754,953.

This patent was applied for by the company Samir, Inc., of the United States. Therein the following is described: in accordance with the present invention, it has been found that the combination of (1) the use of oxygen or oxygen-enriched air and (2) a leach-adsorption system employing activated carbon results in an extremely efficient process for the treatment of gold and/or silver ores or the like.

Regarding the leaching tank, it describes that: The tank 22 is preferably an agitated tank, having a conventional mechanical agitator including blades 23 and shaft 24, powered by a powering device 25 or the like. The slurry within the tank 22 will achieve a certain level, and in accordance with the present invention it is desirable to provide a cover for the solution to minimize the transfer of oxygen from the slurry to the air, and also to minimize the transfer of nitrogen from the air to the slurry. A conventional stationary cover tank may be provided, or a floating cover is provided, such as the disc-shaped cover 26 having a generally flat top surface 27 and a generally concave bottom surface 28 which is actually in contact with the slurry and which has an aperture 29 therein through which the shaft 24 passes. If desired, a permanent lid 30 may also be placed on tank 22, and the entire tank provided with an oxygen atmosphere at about one atmosphere pressure, or provided with an oxygen atmosphere at significantly greater than one atmosphere pressure. The numbers that are mentioned correspond to the parts of the drawings of this patent that are identified with said numbers.

In the description and in the claims of the patent described above a diffuser is not mentioned and is not claimed such as the one of the present invention used in reactors or tanks in dynamic leaching processes for the recovery of gold and silver and the like.

### Patent Application CN108635275.

The invention describes an efficient gold ore pulp leaching tank and relates to the field of mining machinery. The parts of the tank are described and with regard to the stirring system it states that: The agitation paddle is fixedly arranged on the agitation shaft. The agitation propeller is a six-bladed open turbine agitation propeller. The efficient gold ore pulp leaching tank meets the requirements of high leaching efficiency, simple structure and low energy consumption.

Taking into account the above description and in view of the drawings of the leaching tank, it is evident that it does not reproduce the invention of the present invention.

### Utility Model CN201071388Y.

This utility model was applied for in China only by the company SHANDONG GOLD. This document describes a leaching tank for gold ore processing, which has nine sets of aeration devices, wherein a central set (2) is arranged in the center of the leaching tank (1) and eight other sets are arranged evenly around the central aeration. The numbers that are mentioned correspond to the parts of the drawings of this patent that are identified with said numbers.

Due to the above, it is clear that the invention of the Utility Model described above is very different from that of the present patent application, since, for example, the present invention does not have nine sets of aeration devices.

U.S. Pat. No. 5,213,609.

This patent was applied for by the company Du Pont (Australia) Limited.

This patent describes the following:

The present inventors have discovered that the addition of peroxymonosulfuric acid or a salt thereof to the cyanidation process leads to an increase in the amount of precious metals, e.g. silver, copper or gold.

In accordance with a broad form of the present invention, a process is provided for extracting precious metals from a precious metal-containing material comprising mixing the material in a finely divided state with an alkaline cyanide solution to form a mixture and recovering the metal from the solution by known methods, characterized in that said process is carried out in the presence of peroxymonosulfuric acid or a salt thereof and, where necessary, adding oxygen or a source thereof to said mixture to provide a dissolved oxygen level of at least 5 and approximately 6 ppm.

In FIGS. 1A and 1B that accompany the description, it does not appear that the design of the leaching tanks is remotely similar to the invention that is described and claimed in the present patent application.

### Utility Model CN201141037.

The utility model reveals a leaching tank for gold extraction and a microbubble oxidation system, comprising a stirring machine arranged outside the tank body, the stirring machine drives an agitating impeller to rotate a main shaft. The stirring machine drives two impellers to rotate, thus improving the function of agitating the ore magma. Additionally, the microbubble production system is described, adding that oxygen dissolves in water and innumerable microbubbles also play a role in the agitation of the ore magma in the upstream process.

Taking into account the above description and in view of the drawing of the leaching tank described in this Utility Model, it is concluded that it does not reproduce the present invention, since it is not provided with a diffuser like the one of the present invention.

### Utility Model CN203360528U.

In the present invention, a leaching tank is described that is provided with upper blades and lower blades that are part of the stirring system of the leaching tank, the intake duct in the leaching tank is positioned in an intermediate part between the upper and lower blades, in such a way that the pulp is completely and evenly stirred, whereby the leaching time of the ore pulp is ensured, so that the leaching speed and the recovery rate of precious metal are improved.

Based on the above information and in view of the two drawings of this invention, it can be seen that the invention described and claimed in this Utility Model is very different from that of the present invention, since, for example, the design of the blades of the present invention it is different, and the invention of the Utility Model does not include a diffuser like the one of the present invention.

In accordance with what is described and claimed in the documents of the prior art, it is found that the present invention is novel and complies with the requirement of inventive step.

The objects of the invention are described below.

A first object of the present invention is to provide an oxygen diffuser in leaching and cyanide destruction (detox) tanks which increases the efficiency in oxygen application.

Another object of the present invention is to provide an oxygen diffuser in leaching and cyanide destruction (detox) tanks which increases the recovery of values such as gold and silver.

An additional object of the present invention is to provide an oxygen diffuser in leaching and cyanide destruction (detox) tanks, wherein the pulp retention time is shorter and a larger amount of ore can be processed per day.

Yet another object of the present invention is to provide an oxygen diffuser in leaching and cyanide destruction (detox) tanks, which decreases the consumption of reagents used in leaching.

Another object of the present invention is to provide an oxygen diffuser in leaching and cyanide destruction (detox) tanks that is simple to manufacture, has a low-cost and has a long service life. There is no oxygen diffuser in the prior art that complies with each and every one of the characteristics indicated above in the objects of the invention.

### DESCRIPTION OF THE FIGURES

FIG. 1: Shows a diagram of a leaching and cyanide destruction (detox) process, wherein the leaching and cyanide destruction (detox) reactors or tanks are identified.

FIG. 2: Represents a sectional view showing the diffuser inside a leaching reactor or tank and a cyanide destruction (detox) tank.

FIG. 3: Shows a side view of the diffuser of the present invention.

FIG. 4: Shows an isometric view of the diffuser of the present invention.

FIG. 5: Represents a graph of values of dissolved oxygen in leaching tanks with the diffuser of the present invention, over 3 months.

FIG. 6: Shows a graph of values of silver in solution in leaching tanks with the diffuser of the present invention, over 3 months.

FIG. 7: Represents the quantification of silver tailings at a certain time.

FIG. 8: Shows the results of the wad cyanide destruction (detox) process at a certain time.

### DETAILED DESCRIPTION OF THE INVENTION

The present invention, as mentioned above, relates to the recovery of high-value metals such as gold and silver from ores containing them, and to the destruction of cyanide (detox process).

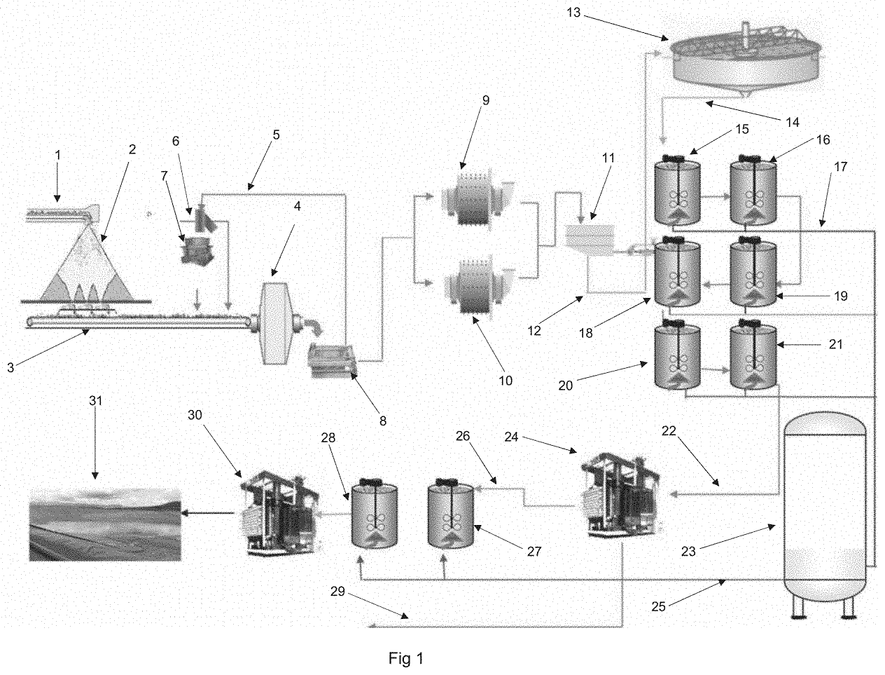

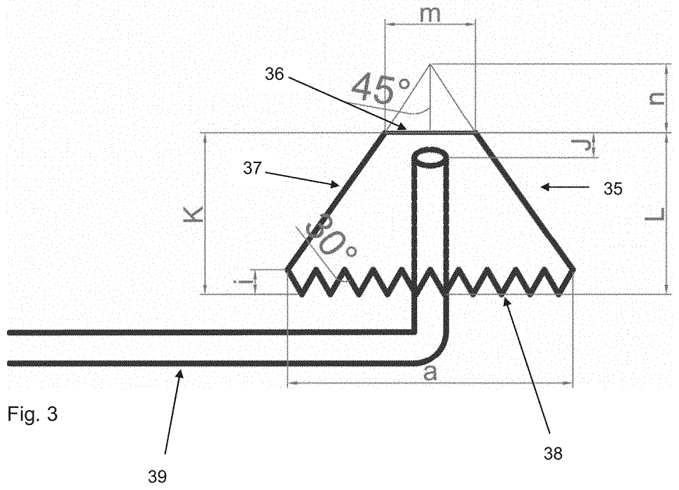

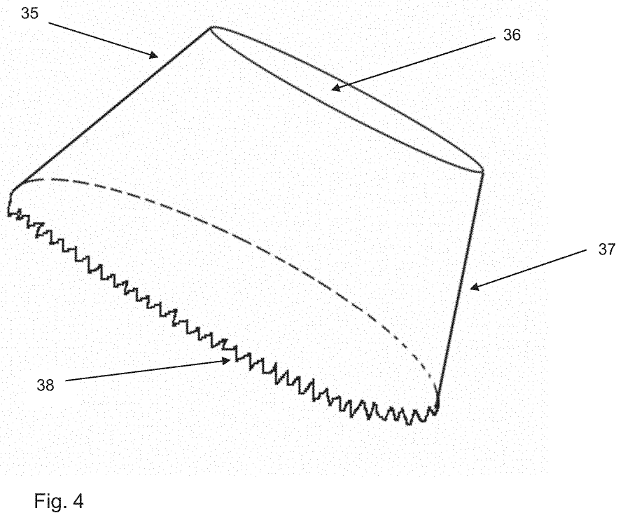

The detailed description of the present invention will make reference to FIGS. 1 to 8, for a better understanding thereof.

With reference to FIG. 1, the dynamic leaching and cyanide destruction (detox) processes are described in general terms, where the initial steps of the leaching process are: crushing and grinding of the ore containing values such as gold and silver.

The crushing step includes the process parts that are identified with the numbers (1) to (8), wherein the ore containing gold and silver is fed through a feeding conveyor (chute) (1) to form a pile of ore (2), the ore is transported through a distribution belt (3) to a semi-autogenous (SAG) mill (4), where the size of the ore is reduced, so that it is delivered with a rock size between 1.5 and 2.5 inches (3.81 and 6.35 cm); in this part of the process at the exit of the semi-autogenous mill a vibrating screen (8) selects the ore size in such a way that the rocks that pass through the screen have the size provided for in the process and the rocks that do not pass through the screen have a larger size and therefore are sent by the return (5) of the semi-autogenous (SAG) mill back to the vibrating screen (6) and to the crusher (7), so that the rocks of ore are reduced in size and returned by the distribution belt (3) to the semi-autogenous (SAG) mill (4), to reduce their size and pass through the vibrating screen (8) to the next step of the process, which is crushing.

The grinding of the ore to further reduce the size of the ore rocks is carried out in horizontal ball mills (9) and (10), in such a way that at the end of the grinding, a ground ore with a standard of 75 μm (Sieve; 200 mesh) is delivered, which is sent to the distribution conveyor (chute) (11).

The object of these two crushing and grinding steps is to release the value (gold and silver), so that they can be beneficiated through leaching.

The next step of the process is carried out in the thickener tank (13), in such a way that the crushed and ground material passes from the distribution conveyor (chute) (11), through the duct (12) to the thickener tank (13), to form an aqueous dispersion to which other compounds have been added; in the thickener (13) the solids that settle on the bottom of the thickener tank (13) are separated and the liquid is eliminated through the upper part of the thickener tank (13).

The next step of this process is leaching, through the bottom of the thickener tank (13), the settled solids are fed through a duct (14) which feeds the pulp formed in a series of leaching tanks, (15), (16), (18), (19), (20) and (21), the leaching tanks normally being provided with a shaft which is attached to a motor and propellers are attached to the shaft; when the shaft rotates the propellers move the pulp with several purposes; these tanks are supplied with oxygen from the oxygen supply tank (23), through the oxygen supply pipe (17) for leaching. The pulp is retained in these tanks for a previously determined time, which ensures the beneficiation of the value; by means of the propeller, the already ground ore (pulp) is maintained in aqueous suspension with a percentage of solids between 50-55%. Said propeller also homogenizes oxygen throughout the volume of the same tank. Along the entire circuit of leaching tanks, the values are dissolved by means of the cyanide reagent, oxygen and water. This process is carried out in a period of time between 72 and 124 h; the time depends on the tonnage of ore processed, the association of ores with the value, the grade of the ore, etc. The reaction that describes this process is:

4Au+8 Cn⁻+O₂+2H₂O=4Au(Cn)₂⁻+4OH⁻

The complex formed with gold and cyanide Au(Cn) in ionic form, which forms the pregnant solution, is sent through duct (22) to the plant (24), where it is precipitated and filtered; finally the value-rich solution passes to a casting process through the duct (29). A similar reaction is described for silver (Ag). The residual pulp that is produced in the precipitation and filtration plant (24) has a significant concentration of cyanide which cannot be discarded until the cyanide concentration is lowered, for which purpose it is subjected to the cyanide destruction (detox) process. The residual pulp is sent through the duct (26) to the cyanide destruction (detox) process. This process being carried out in cyanide destruction tanks (27) and (28) with the same characteristics as the leaching tanks (15), (16), (18) to (20) and (21). The reaction that describes this process is as follows:

2NaCn+Me(Cn)4Na₂+3Na₂S₂O₅+6O₂+3H₂O=6NaOCn₂+4NaHSO₄+Me(HSO₄)₂

The tank (23) contains pressurized oxygen and supplies it to the cyanide destruction (detox) tanks through the pipe (25). The product resulting from the cyanide destruction (detox) tanks (27) and (28) passes to a filtration step (30) and subsequently to what is known as the tailings dam (31). Regarding the cyanide destruction (detox) step, the final step of the mineral beneficiation process is to discard the worthless ore (without gold or silver) without any cyanide concentration; this worthless ore without cyanide concentration accumulates in the tailings dam, without harmful effects on the environment.

Temperature is important in both the leaching and destruction of cyanide processes At higher temperatures the oxygen concentration is lower, because there is greater movement of molecules in the system, which leads to oxygen not remaining within the pulp, leaving it and entering the atmosphere. However, it is a parameter that we cannot control, since the temperature in the pulp increases from the grinding process.

In the leaching process there are two limiting reagents, cyanide and oxygen; if there is a lack of either of them the kinetics are slow. In practice cyanide is added in excess to guarantee a higher dissolution of values and as a consequence a greater recovery; however, when pure oxygen is added, concentrations of 15 to 20 ppm can be reached and it is not necessary to use an excess of cyanide. For the cyanide destruction (detox) process, the reagent that is used is metabisulfite, the suitable oxygen concentration for this process being approximately 15 ppm. The concentration of cyanide and metabisulfite can be reduced because oxygen has the capacity to oxidize ores such as iron and copper sulfides, consumers of cyanide and metabisulfite.

The diffuser of the present invention is used both in the leaching tanks and in the cyanide destruction (detox) tanks. According to the present invention the leaching tanks are cylindrical retention tanks, having a suitable proportion of height and diameter, as well as maintaining a ratio between the length of the shaft and the diameter of the propeller.

As can be seen in the chemical reactions of both processes, shown above, oxygen is required. Thus, in both cases the use of the diffuser of the present invention is essential to guarantee the oxygen concentration required for both processes to be carried out efficiently.

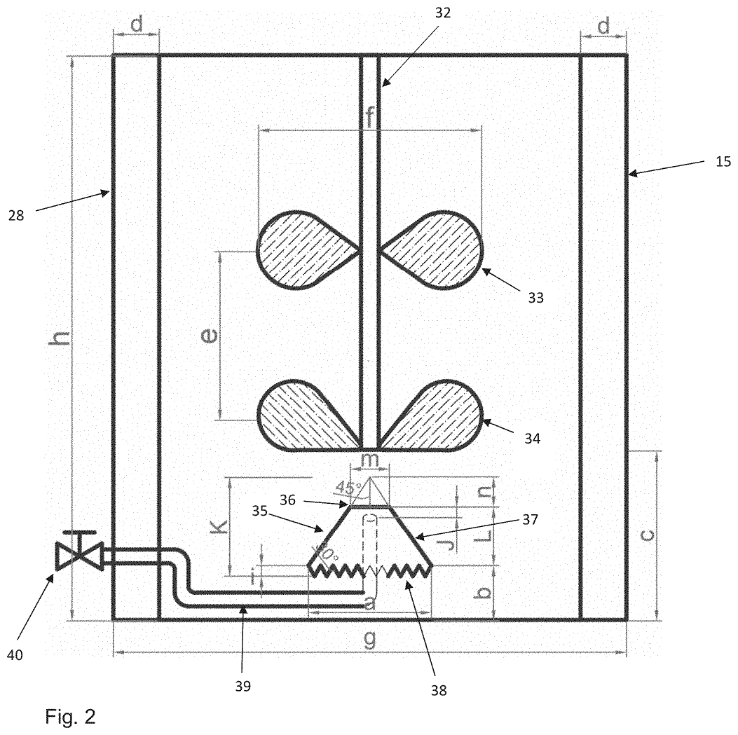

FIGS. 2, 3 and 4 show the diffuser of the present invention in detail. FIG. 2 shows that it is inside a leaching or cyanide destruction (detox) tank, for example (15) or (28), also inside these tanks, a shaft (32) is shown, which is attached to a motor, not shown, that makes it rotate; it has 2 sets of propellers attached, an upper one (33), and a lower one (34), where the lower propeller is at the level of the end of the shaft (32). By moving the sets of propellers (33) and (34) together with the shaft (32), and the region of partitions or deflectors d), the aqueous pulp it contains, ground ore with values, are made to come into close contact with reagents and oxygen. The diffuser of the present invention (35) is in the lower part of the shaft (32) separated from said shaft inside the leaching tank (15), for example, or the cyanide destruction (detox) tank (28), which is fastened to the base of the leaching or cyanide destruction (detox) tank (15) or (28), for example, either by means of metal brackets, not shown. Their position must be at a height from the bottom of the leaching or cyanide destruction (detox) tank (15) or (28), for example, of 10% of the total height of the leaching tank or cyanide destruction (detox) tank (15) or (28), for example. The diffuser (35) is preferably constructed from carbon steel sheet, for example, gauge 7 (4.55 mm) to gauge 4 (5.69 mm); the gauge is an important part of the diffuser since it is subject to wear due to the solids suspended in the pulp and the reagents it contains; in addition, a greater thickness extends the life and/or maintenance period of the diffuser. The carbon steel sheet can be replaced by a stainless-steel sheet, which can make the diffuser more expensive, but can also offer a longer life and longer maintenance period.

The diffuser (35) is structured as a straight truncated cone and can also be described as the sectioning of the cone parallel to the base, eliminating the part that has the apex of the cone. It has a flat upper horizontal wall (36), of smaller diameter, which continues in a conical surface (37); the bottom of the cone is open, forming an inner space, the lower end of the conical surface of greater diameter, having angular cuts (38) between 25° and 35° throughout its periphery, the height (i) of the angular cuts (38) having a ratio between 8% and 12% of the total height K of the diffuser Oxygen flows from the inner space of the diffuser (35) and passes through the angular cuts (38) to regulate the size of the oxygen bubbles that flow towards the pulp, the diffuser (35) having a specific dimension ratio with respect to the leaching tank (15) or cyanide destruction (detox) tank (28), including the shaft and propellers, which make it novel and involve an inventive step; the diffuser (35) is located at the lower part of the lower end of the shaft (32), separated from said shaft (32), also separated from the bottom of the leaching and cyanide destruction (detox) tank; a pipe (39), which has an oxygen inlet valve (40) outside the wall of the leaching or cyanide destruction (detox) tank (15) or (28), and an oxygen outlet that reaches the central part of the inner space of the diffuser (35), conveys oxygen which must arrive just in the internal central part of the diffuser, the pipe outlet (39) being at a distance from the internal upper wall (36) of the diffuser (35) which is between 5% and 9% of the total height K of the diffuser.

The lower larger diameter (a) of the diffuser (35) is sized in a range between 3/16 and 5/16 of the diameter of the leaching tank (15), for example, or of the cyanide destruction (detox) tank (28), for example.

The diffuser of the present invention guarantees a suitable concentration of oxygen between 15 and 20 ppm with an oxygen volume ratio of 0.7 to 1.0 kg of oxygen per ton of ore; with respect to other diffusion systems, efficiency ranges from 1.0 to 1.5 kg of oxygen per ton of ore. This oxygen ratio is due to the number and size of bubbles generated by the diffuser of the present invention; the ideal bubble size is equal to or less than 5 mm. The angle of the cuts in the toothed part of the diffuser determines the bubble size: at smaller angles, between 25° and 35°, there is greater bubble coalescence, therefore a greater amount of bubbles with diameters greater than 5 mm are visible on the surface of the tanks. Maintaining the ratio between the size and position of the propellers and the diffuser inside the tanks also ensures that these bubbles are kept separate.

The diffuser (35) of the present invention is used in leaching reactors or tanks for mineral beneficiation processes such as dynamic leaching, for the extraction of gold and silver, as well as for the cyanide destruction (detox) process, the final step of the mineral beneficiation process; this last step is to discard the worthless ore (without gold or silver) without any concentration of cyanide. This worthless ore with no cyanide concentration accumulates in the tailings dam, with no harmful effects on the environment.

A relevant aspect of the present invention is the ratio of dimensions of the diffuser itself with respect to either the leaching tank (15) or the cyanide destruction (detox) tank (28). The ratio of dimensions expressed for these tanks are the ideal ones. However, not all installed tanks (15) or (28) currently maintain this ratio of dimensions and the foregoing is not a condition for adapting the diffuser (35) to such tanks.

The ratio of dimensions of the diffuser (35) is shown in FIG. 2, in which the letters that appear have the following meaning.
a) larger diameter of the diffuser (35)
b) height from the base of the tank (15) or (28), to the beginning of the angular cuts (38), of the diffuser (35).
c) height from the base of the tank (15) or (28) to the lower end of the propeller shaft (32).
d) region of screens or deflectors in the leaching tanks (15) or cyanide destruction (detox) tanks (28), which help to stir the pulp.
e) distance between the upper propeller (33) and the lower propeller (34).
f) width of the upper propeller (33) and of the lower propeller (34).
g) tank diameter (15) or (28).
h) tank height (15) or (28).
i) height of the angular cuts (38)
j) space between the internal upper horizontal wall (36) of the diffuser (35) and the pipe outlet (39).
k) distance from the end of the angular cuts (38) to the vertex that would be formed by the upper extension of the conical surface (37).
l) distance from the beginning of the angular cuts (38) to the horizontal wall (36) of the diffuser (35).
m) width of the horizontal wall (36) of the diffuser (35)
n) distance from the horizontal wall (36) of the diffuser (35) to the vertex that would be formed by the continuation towards the upper part of the conical surface (37).

The ratio of dimensions is defined below, using the letters “a” through “n”, shown in FIG. 2.
a) the larger diameter of the lower part of the diffuser (35) is between 3/16 and 5/16 of the diameter (g) of the tank (15) or (28)
b) the distance between the base of the angular cuts (38) of the diffuser (35) and the bottom of the tank (15) or (28) is between 8% and 12% of the total height (h) of the tank (15) or of the tank (28).
c) the height between the end of the shaft (32) and the bottom of the tank (15) or (28) is between 23% and 27% of the total height (h) of the tank (15) or of the tank (28).
d) the partitions or deflectors have a ratio between 2/32 and 4/32 of the diameter (g) of the tanks (15) or (28).
e) the distance between the middle part of the propellers (33) and (34) is less than 0.385 of the diameter (g) of the tank (15) or (28).
f) the width of the propellers (33) and (34) preferably have a ratio between 2/8 and ⅜ of the diameter of the tank (15) or (28).
g) is the diameter of the tank (15) or (28).
h) the height (h) of the tank (15) or (28), divided by the diameter (g) of the tank (15) or (28), is equal to 1. (h/g=1)
i) the height of the angular cuts (38) has a ratio between 8 and 12% with respect to the height (K) of the diffuser (35).
j) the pipe outlet (39) is at a distance from the internal upper wall of the diffuser, which is between 5% and 9% of the total height K of the diffuser.
k) is the height from the base of the angular cuts (38) to the vertex that would be formed by the upward extension of the conical surface (37), which is between ⅜ and ⅝ of the larger diameter a) of the lower part of the diffuser (35)
l) is the distance between the beginning of the angular cuts (38) and the upper horizontal wall (36) of the diffuser (35), which is between 6/8 and ⅞ of the height K.
m) is the width of the upper horizontal wall (36) of the diffuser (35), which is between 5/32 and 8/32 of the larger, lower diameter (38) of the diffuser (35).
n) is the height from the upper base (36) of the diffuser (35) and the vertex that would be formed by the upper extension of the conical surface (37), which is between 5/32 and 8/32 of the height K.

Leaching and cyanide destruction (detox) tanks are sized based on the amount of ore to be processed and the retention time the ore needs to obtain the greatest amount of recovery of values.

With the diffuser of the present invention in the two processes, leaching and cyanide destruction (detox process), the following results are obtained, not reported in the prior art.
1.—The efficiency in the application of oxygen is increased, resulting in up to 30% less consumption.
2.—The consumption of reagents such as cyanide and metabisulfite is reduced by up to 20%.
3.—Application of oxygen in the aforementioned processes accelerates the kinetics of both reactions.
4.—The retention time in the leaching and cyanide destruction (detox) reactors or tanks is shorter and a greater amount of ore is processed per day or,
5.—It is possible to stop operating tanks in the retention circuits of the leaching and cyanide destruction (detox) processes,
6.—Value recovery is increased in the case of leaching between 4 and 6% in silver and up to 0.5% in gold.
7.—The leaching and cyanide destruction (detox) processes become more stable once the oxygen concentration is maintained.

### EXAMPLES

### Example 1

Below are examples of application of the present invention.

A comparative test of diffusers known in the state of the art was carried out with respect to the diffuser of the present invention to determine the efficiency in oxygen consumption.

Table I below shows the results produced when using several types of diffusers, showing that each one of them has a certain degree of efficiency in the application of oxygen; to obtain the same results, the diffusers used in this test are:

A perforated tube diffuser, which as its name indicates is a perforated tube through which oxygen circulates. A static mixer, which is formed by a series of fixed elements, usually helical, enclosed within a tubular casing, and

A shaft or hollow shaft diffuser that is formed by a hollow part at the lower part of the shaft or rotary shaft, which has a plurality of oxygen distribution openings, forming an oxygen distribution groove in each oxygen distribution opening.

The highest consumption was when the perforated tube was used, with a ratio of 1.7 Kg O₂/Ton of pulp. The static mixer type diffuser had a consumption of 1.1 kg O₂/Ton of pulp,

TABLE I

| | Oxygen ratio | Produced bubble |
|---|---|---|
| Diffuser Type | Kg O₂/Ton of ore | size mm |
| Perforated tube | 1.7 | 10 |
| Static mixer | 1.1 | 15 |
| Shaft or hollow shaft | 0.9 | 7 |
| Truncated cone. (present | 0.7 | 5 |
| invention) | | |

the shaft or hollow shaft type had a consumption of 0.9 kg O₂/Ton of pulp and the truncated cone diffuser of the present invention had a consumption of 0.7 KgO₂/Ton, that is, 30% less oxygen consumption if we take 1 KgO₂/Ton as a base.

The diffuser of the present invention produced a bubble size of 5 mm, which was the object sought since coalescence in the oxygen droplets is observed with larger sizes.

### Example 2

2.—The present example shows that the consumption of reagents such as cyanide and metabisulfite decreases when oxygen and the diffuser of the present invention are used. For the cyanide neutralization process, two reagents are required, metabisulfite and an oxidant. The latter can be air, pure oxygen, or any other reagent able to donate electrons.

The values are reported in Table II.

TABLE II

| parameters | 8 am | 10 am | 12 pm | 14 pm | 16 pm | 20 pm | 22 pm5 |
|---|---|---|---|---|---|---|---|
| Solids percentage [%] | 55 | 54 | 55 | 56 | 55 | 54 | 54 |
| pH | 8.62 | 8.66 | 8.48 | 8.54 | 8.38 | 8.59 | 8.49 |
| Initial cyanide [ppm] | 1175 | 1125 | 1210 | 1170 | 1125 | 1180 | 1120 |
| Dissolved oxygen | 1.13 | 1.77 | 8.5 | 7.92 | 4.60 | 3.61 | 3.71 |
| [ppm] | | | | | | | |
| O₂ flow rate [m³/h] | 341.6 | 338.5 | 338.5 | 338.2 | 340.8 | 335.1 | 345.2 |
| Metabisulfite flow rate [m³/h] | 0.86 | 0.86 | 0.84 | 0.84 | 0.88 | 0.94 | 0.94 |
| Final cyanide in field [ppm] | 0 | 0 | 0 | 0 | 0 | 0 | 0 |

The values reported in Table II correspond to an operation carried out in a cyanide destruction (detox) plant, in which metabisulfite is required for cyanide neutralization. Before oxygen addition the metabisulfite flow was 1.2 m³/h; at the time of adding oxygen with the diffuser of the present invention in the cyanide neutralization tank, the consumption of this reagent was reduced by 30%.

According to the results shown in Table II, it is shown that, with the application of oxygen and the diffuser of the present invention, the consumption of reagents such as metabisulfite is reduced by up to 30%.

### Example 3

This example demonstrates that the application of oxygen in the leaching and cyanide neutralization processes accelerates the kinetics of both reactions.

In addition, the retention time in the leaching and cyanide destruction (detox) reactors or tanks is lower and a greater amount of ore is processed per day.

Table III shows the results obtained with the application of oxygen and with the diffuser (35) in a leaching process.

TABLE III

| Leaching process | Without oxygen | With oxygen |
|---|---|---|
| Production Capacity (Ton/day) | 350 | 475 |
| Gold Recovery (%) | 79 | 79.76 |
| Silver Recovery (%) | 74 | 76.53 |
| Stirring tanks | 11 | 7 |

According to the results expressed in Table III, the first 3 parameters increase, which is positive, and in terms of the number of leaching tanks, the number is reduced, which is also positive, indicating that the tanks no longer operate in the retention circuits of the leaching and cyanide destruction (detox) processes.

### Example 4

This example shows that the leaching process is very stable, which reduces the number of tanks in operation.

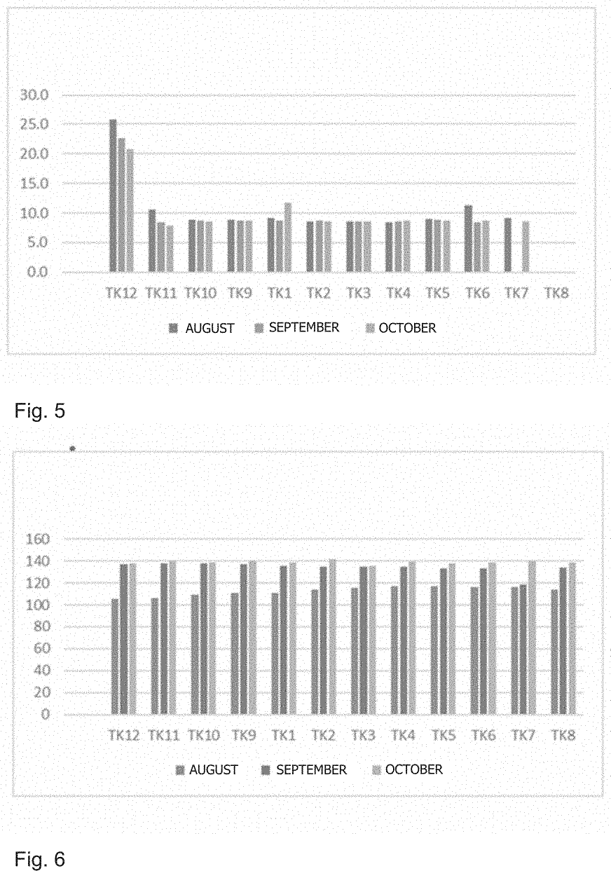

In a leaching plant, the application of oxygen began using the diffuser (35) of the present invention, initially being applied in a single retention tank and subsequently in the entire circuit of tanks. In the graphs of FIGS. 5 and 6, the oxygen dissolution values in the pulp and the increase in the dissolution of values are shown, in addition to the fact that the process is very stable throughout the tank circuit, which led to the decision to stop operating the last two retention tanks.

The graph of FIG. 5 shows the amount of dissolved oxygen in several leaching tanks The ordinate shows the dissolved oxygen values in ppm, and in the abscissa shows the number of tanks; of the 3 bars that correspond to each tank. The one on the left refers to the month of August, the middle one to the month of September and the one on the right to the month of October. The graph of FIG. 6 shows the values of silver in solution in ppm in the ordinates and the number of tanks in the abscissas, which correspond to the number of tanks in FIG. 5. Of the 3 bars that correspond to each tank, the one on the left refers to the month of August, the middle one to the month of September and the one on the right to the month of October. In the tank circuit, tank 12 was the only one that received oxygen using the diffuser of the present invention; however, since the pulp passes from tank to tank in a cascade, an oxygen concentration between 10 and 12 ppm is maintained in all the other tanks of the circuit, obtaining as a result an increase in silver dissolution per month, as seen in FIG. 6.

### Example 5

This example shows the increase in value recovery in the case of leaching, between 4 and 6% in silver and up to 0.5% in gold.

This example was carried out in a leaching plant applying oxygen and using the diffuser (35) of the present invention. Quantifying the values in the silver tailings is very important in order to assess what was really dissolved in the leaching process. By presenting fewer values in the tailings, it indicates that there are more values in the pregnant solution, which can translate into greater silver recovery.

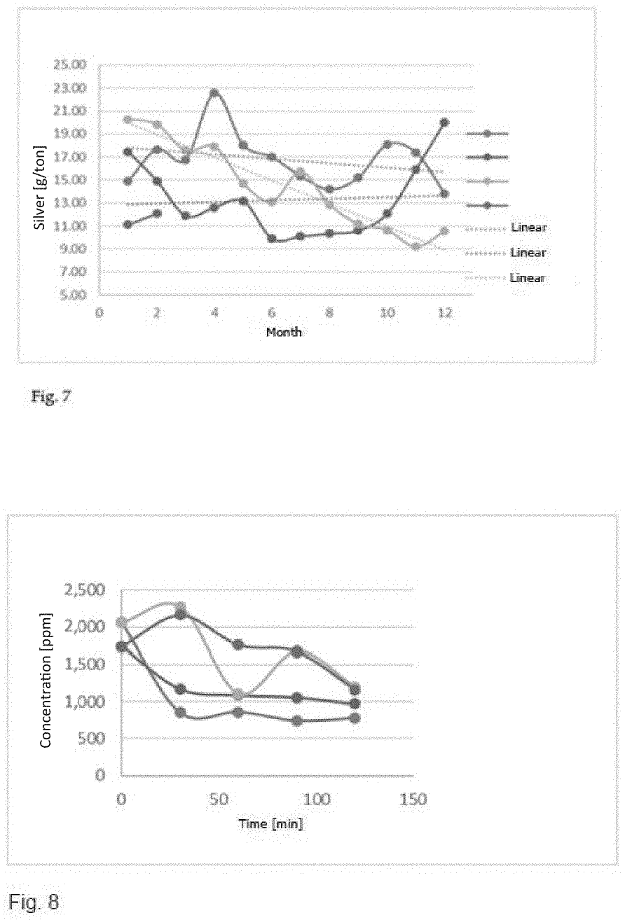

The graph of FIG. 7 shows the values of silver in tailings in g/ton in the ordinate and the number of months in the abscissa; in this graph there are 4 lines, 3 complete and one with a short duration; the first line starts with values of 15 g/ton and rises to 23 g/ton in month 4 and ends in month 12 with a value of approximately 13.8 g/ton; the second line starts with values slightly above 17 g/ton, decreases in month 6 and ends with a high value of approximately 20 g/ton. In the results obtained so far, no oxygen application was used with the diffuser (35) of the present invention until the operation represented by the third line, which used oxygen with the diffuser (35). It can be seen that the third line starts with a value of approximately 20.5 g/ton and ends with a value slightly under 11 g/ton; the dashed lines are the linear expression of the 3 curved lines described above. The above shows that the application of oxygen with the diffuser (35) decreases the silver in tailings, which means that the recovery of silver increases, the same as with gold.

### Example 6

This example shows that the leaching and cyanide destruction (detox) processes become more stable once the oxygen concentration is maintained.

This example was performed at a WAD cyanide destruction (detox) plant. WAD cyanide stands for weak acid dissociable metal cyanide complexes.

The graph of FIG. 8 shows the results in the WAD cyanide destruction (detox) process, with the application of oxygen and the diffuser (35) of the present invention. The graph shows the behavior of 4 treatments. The line in the lower part corresponds to the behavior of the treatment of WAD cyanide with oxygen and with the diffuser of the present invention; the next line represents the treatment of copper with oxygen and with the diffuser of the present invention; the following line corresponds to the WAD cyanide air treatment and the top line corresponds to the copper air treatment.

The reduction in WAD cyanide concentration is evident when oxygen is used with the diffuser (35) of the present invention.

Cyanide is optimally destroyed on average 36% more with the application of oxygen by means of the diffuser (35) of the present invention. In addition to reducing the cyanide concentration, the process becomes more stable, and drastic changes from one point to another are not observed. This favors the process, in the addition of reagents and their consumption.

It has been shown in the above description that by applying oxygen and the diffuser of the present invention, the leaching and cyanide destruction (detox) processes become more efficient due to the application of oxygen, with a reduction of up to 30% in consumption; the consumption of reagents such as cyanide and metabisulfite is reduced by up to 20%; the application of oxygen in the aforementioned processes accelerates the kinetics of both reactions; the retention time in the leaching and cyanide destruction (detox) reactors or tanks is less and a greater amount of ore is processed per day; in addition, tanks can stop operating in the retention circuits of the leaching and cyanide destruction (detox) processes; the recovery of values in the case of leaching increases between 4 and 6% in silver and up to 0.5% in gold, and the leaching and cyanide destruction (detox) processes become more efficient and stable once the oxygen concentration is maintained.

1. An oxygen diffuser that is part of leaching and cyanide destruction tanks, for the recovery of high-value metals such as gold and silver from ores containing them and for cyanide destruction, the tanks being made up of: a rotating shaft (32), 2 sets of propellers, an upper one (33) and a lower one (34), attached to the shaft (32) and an area of partitions or deflectors; characterized in that the diffuser (35) is structured as a right truncated cone with a horizontal flat upper wall (36) having a smaller diameter, a conical surface (37), and the bottom of the diffuser (35) that is open, forming an inner space, the conical surface (37) having at its lower end with a larger diameter angular cuts (38) between 25° and 35° around its entire periphery; a pipe (39) that conveys oxygen, having an inlet valve (40) outside the wall of the leaching or cyanide destruction tank, (15) or (28), and an oxygen outlet just in the inner center part of the diffuser (35); the diffuser (35) regulates the size of the oxygen bubbles, having a ratio of specific dimensions with respect to the leaching tank (15) or cyanide destruction tank (28); the diffuser (35) is located at the lower part of the lower end of the shaft (32), separated from said shaft (32), also separated from the bottom of the leaching and cyanide destruction tank, it is fastened to the internal walls or the bottom of such tanks, and is made of a material that resists the wear to which it is subjected due to the solids suspended in the pulp and the reagents it contains.

2. An oxygen diffuser that is part of leaching and cyanide destruction tanks, for the recovery of high-value metals such as gold and silver from ores containing them, according to claim 1, characterized in that: the diffuser (35) is located at a height (b) from the bottom of the leaching tank or cyanide destruction tank (15) or (28) which is between 8% and 12% with respect to the total height of these tanks; the angular cuts (38) have a height i) that has a ratio between 8% and 12% of the total height K of the diffuser; the diffuser (35) has a diameter a) that is between 3/16 and 5/16 of the diameter g) of the leaching tank or cyanide destruction tank (15) or (28); and the center of the diffuser (35) is aligned with the center of the shaft (32).

3. An oxygen diffuser that is part of leaching and cyanide destruction tanks, for the recovery of high-value metals such as gold and silver from ores containing them, according to claim 1, characterized in that: the pipe (39) has an outlet that is at a distance J) from the internal upper wall (36) of the diffuser (35), which is between 5% and 9% of the total height K) of said diffuser; the height K) from the base of the angular cuts (38) to the vertex that would be formed by the upward extension of the conical surface (37), is between ⅜ and ⅝ of the larger diameter a) of the bottom part of the diffuser (35).

4. An oxygen diffuser that is part of leaching and cyanide destruction tanks, for the recovery of high-value metals such as gold and silver from ores containing them, according to claim 1, characterized in that the distance L) between the beginning of the angular cuts (38) and the upper horizontal wall (36) of the diffuser (35) is between 6/8 and ⅞ of the height K of the diffuser; the upper horizontal wall (36) has a width m) that is between 5/32 and 8/32 of the lower larger diameter a) of the diffuser; and the height n) from the upper wall (36) of the diffuser (35) and the vertex that would be formed by the upper extension of the conical surface (37), is between 5/32 and 8/32 of the height K of the diffuser.

5. An oxygen diffuser that is part of leaching and cyanide destruction tanks, for the recovery of high-value metals such as gold and silver from ores containing them, according to claim 1, characterized in that: the height c) from the base of the tank (15) or (28) to the lower end of the propeller shaft (32), is preferably between 23% and 27% of the total height (h) of the tank (15) or the tank (28); the partitions or deflectors in the region d) have a ratio between 2/32 and 4/32 of the diameter g) of the tanks (15) or (28); the height e) between the middle part of the propellers (33) and (34) is preferably less than 0.385 of the diameter (g) of the tank (15) or (28); the width f) of the propellers (33) and (34) is preferably in a ratio between 2/8 and ⅜ of the diameter g) of the tank (15) or (28); and the height h) of the tank (15) or (28) divided by the diameter g) of said tanks is equal to 1. (h/g=1).

6. Leaching process for the recovery of high-value metals such as gold and silver from ores containing them and cyanide destruction process, characterized by the supply of oxygen to a leaching tank through the pipe (39) into the diffuser (35) and passing through the toothed part (38) of the diffuser (35), which has angular cuts (38) between 25° to 35° for generating a bubble size with a diameter equal to or less than 5 mm, producing oxygen concentrations between 15 and 20 ppm, without using excess cyanide, with an oxygen volume ratio of 0.7 to 1.0 kg of oxygen per ton of ore.

7. Leaching process for the recovery of high-value metals such as gold and silver from ores containing them and cyanide destruction process, according to claim 6, characterized by the supply of oxygen to a leaching tank through the pipe (39) into the diffuser (35), and passing through the toothed part (38) of the diffuser (35), which has angular cuts (38) between 25° and 35° for generating a bubble size with a diameter equal to or less than 5 mm, which increases the efficiency in the application of oxygen, resulting in up to 30% less consumption.

8. Leaching process for the recovery of high-value metals such as gold and silver from ores containing them and cyanide destruction process, according to claim 6, characterized in that in the leaching process the recovery of values is increased between 4% and 6% in silver and 0.5% in gold.

9. Leaching process for the recovery of high-value metals such as gold and silver from ores containing them and cyanide destruction process, according to claim 6, characterized in that the retention time of the pulp in the leaching tanks is less, whereby a greater quantity of ore is processed per day, stopping tank operation in the retention circuits of the leaching processes.

10. Leaching process for the recovery of high-value metals such as gold and silver from ores containing them and cyanide destruction process, according to claim 6, characterized by supplying oxygen to a cyanide destruction tank containing residual pulp through the pipe (39) into the diffuser (35) and passing through the toothed part (38) of the diffuser (35), which has angular cuts (38) between 25° and 35°, for generating a bubble size with a diameter equal to or less than 5 mm and producing oxygen concentrations of approximately 15 ppm, which decreases by up to 20% the concentration of reagents, cyanide and metabisulfite, and produces a ore without value and without any concentration of cyanide, which accumulates in a (tailings) dam without harmful effects on the environment.

11. Leaching process for the recovery of high-value metals such as gold and silver from ores containing them and cyanide destruction process, according to claim 10, characterized in that with the application of oxygen and the diffuser (35), cyanide is destroyed on average about 30% more than if air were used.
